(19) United States
(12) Patent Application Publication
(10) Pub. No.: US 2011/0128264 A1
(43) Pub. Date: Jun. 2, 2011

(54) TRANSFLECTIVE DISPLAY DEVICE

(75) Inventors: Jiun-Haw Lee, Taipei (TW); Tien-Lung Chiu, Taipei City (TW)

(73) Assignee: National Taiwan University, Taipei (TW)

(21) Appl. No.: 12/765,717

(22) Filed: Apr. 22, 2010

(30) Foreign Application Priority Data
Nov. 27, 2009 (TW) 098140595

(51) Int. Cl. G09G 5/10; G09G 3/30; G09G 3/36; G02F 1/1335; G02F 1/1334

(52) U.S. Cl. 345/207; 345/77; 345/102; 349/114; 349/86

(57) ABSTRACT

A transflective display device includes upper and lower substrates, and a plurality of pixel regions that are disposed between the upper and lower substrates. Each of the pixel regions is controllable to switch between a bright state and a dark state, and includes a liquid crystal display structure, an emissive display structure, and a photovoltaic structure. The photovoltaic structure is capable of absorbing light to generate an electrical power. The liquid crystal display structure is controllable to operate between a transmissive mode and a reflective mode. The emissive display structure is controllable to emit graded light or to not emit light.

### CROSS-REFERENCE TO RELATED APPLICATION

This application claims priority of Taiwanese application no. 098140595, filed on Nov. 27, 2009.

### BACKGROUND OF THE INVENTION

1. Field of the Invention

This invention relates to a display device, more particularly to a transflective display device.

2. Description of the Related Art

Transflective display devices provide improved visibility in bright and dark ambient conditions. Typically, a transflective display device includes a plurality of pixel regions each of which is constituted by a liquid crystal display structure and an emissive display structure. For displaying an image, the liquid crystal display structure in each pixel region is controlled to operate at a reflective mode or a transmissive mode. The emissive display structure in each pixel region is controlled to operate at an emissive state to emit light, or at a non-emissive state to not emit light.

Such kind of the transflective display device is disclosed in U.S. Pat. No. 7,440,071. In this patent, the liquid crystal display structures and the emissive display structures are disposed side by side, and operate at the same time for displaying an image.

However, when the ambient condition is dark (for example, dark indoor environment), the reflective light from the liquid crystal display structures is relatively weak. When the ambient condition is bright (for example, daylight environment), the light emitted from the emissive display structures is hard to produce clear image against the ambient light. Therefore, the transflective display device in the patent has poor ambient contrast ratio and aperture ratio (a ratio of area in which active display actually occurs to the entire area of the transflective display).

### SUMMARY OF THE INVENTION

Therefore, an object of the present invention is to provide a transflective display device with power saving and a high ambient contrast ratio (A-CR).

Another object of the present invention is to generate an electrical power by itself through photoelectric effect to feedback and drive the transflective display device.

Yet another object of the present invention is to provide a transflective display device that has a vertical integrated stack structure of a liquid crystal display structure, an emissive display structure, and a photovoltaic structure, such that the high aperture ratio of the transflective display device can be achieved.

Accordingly, a transflective display device of the present invention comprises:

upper and lower substrates; and

a plurality of pixel regions, each of which includes a liquid crystal display structure, an emissive display structure, and a photovoltaic structure, all of which are disposed one over the other to form a stack between the upper and lower substrates.

The photovoltaic structure is capable of absorbing light to generate an electrical power for driving the liquid crystal display structure and the emissive display structure.

Each of the pixel regions is controllable to switch between a bright state and a dark state.

The liquid crystal display structure is controllable between a transmissive mode and a reflective mode.

The emissive display structure is controllable to emit light or to not emit light.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view of a pixel region that is controlled in a dark state when an ambient condition is dark (i.e., an emissive display structure is controlled to be non-emissive, and a liquid crystal display structure is controlled to be transmissive) according to the first embodiment of the present invention;

FIG. 2 is the same view as FIG. 1 but illustrating the pixel region being controlled in a bright state when the ambient condition is dark (i.e., the emissive display structure is controlled to be emissive, and the liquid crystal display structure is controlled to be transmissive);

FIG. 3 is the same view as FIG. 1 but illustrating the pixel region being controlled in the dark state when the ambient condition is bright (i.e., the liquid crystal display structure is controlled to be transmissive, the emissive display structure is controlled to be non-emissive, and the photovoltaic structure absorbs an ambient light);

FIG. 4 is the same view as FIG. 1 but illustrating the pixel region being controlled in the bright state when the ambient condition is bright (i.e., the liquid crystal display structure is controlled to be reflective, and the emissive display structure is controlled to be non-emissive);

FIG. 5 is a schematic view of a pixel region according to the second embodiment of the present invention;

FIG. 6 is a schematic of a pixel region according to the third embodiment of the present invention; and

FIG. 7 is a schematic of a pixel region according to the fourth embodiment of the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

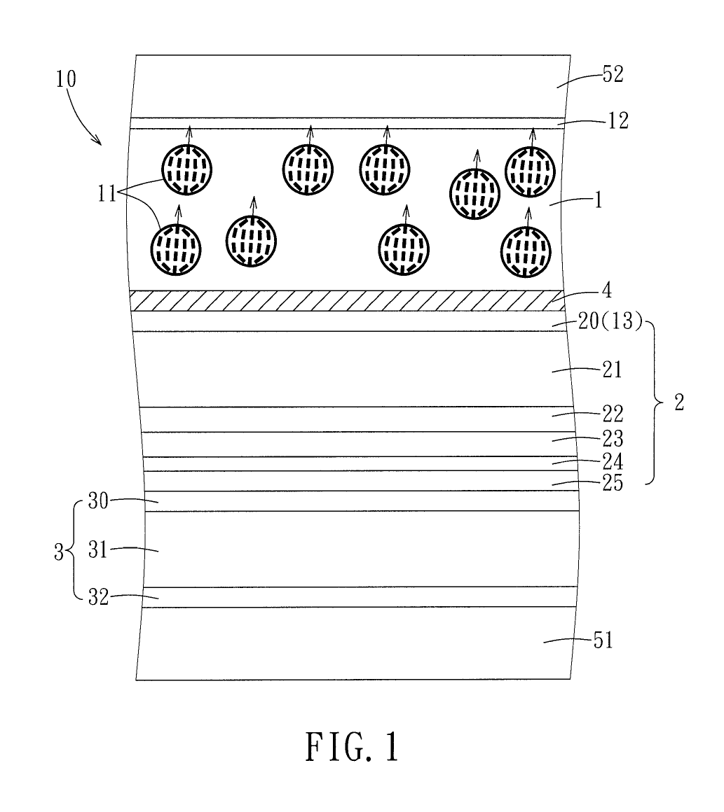

Referring to FIGS. 1 to 4, a transflective display device according to the first embodiment of the present invention comprises lower and upper substrates 51 and 52, and a plurality of pixel regions 10 (only one is shown) between the lower and upper substrates 51, 52.

The lower and upper substrates 51 and 52 are made of a light-transmissive material, for example, quartz, glass, fibers, semiconductor materials, polymers, etc., based on the actual requirement of the transflective display device.

Each of the pixel regions 10 is a pixel or a subpixel based on the design of the transflective display device. For the sake of simplicity, only one pixel region 10 is described below.

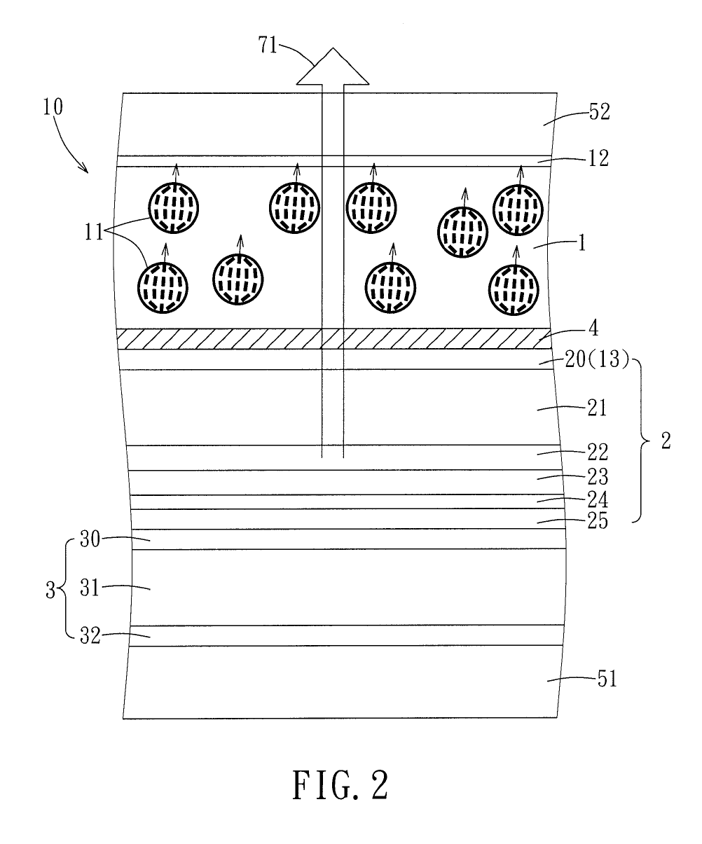

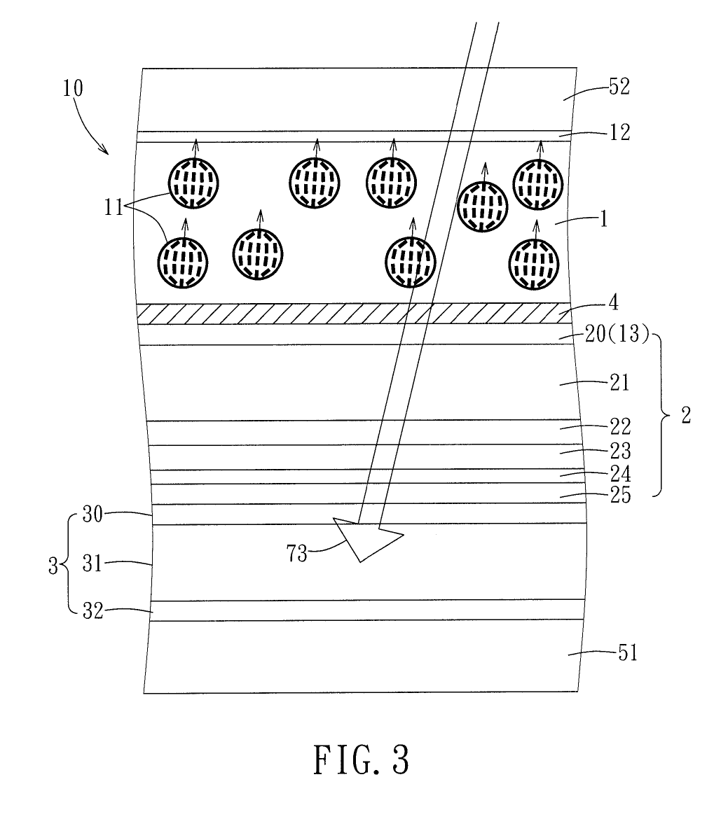

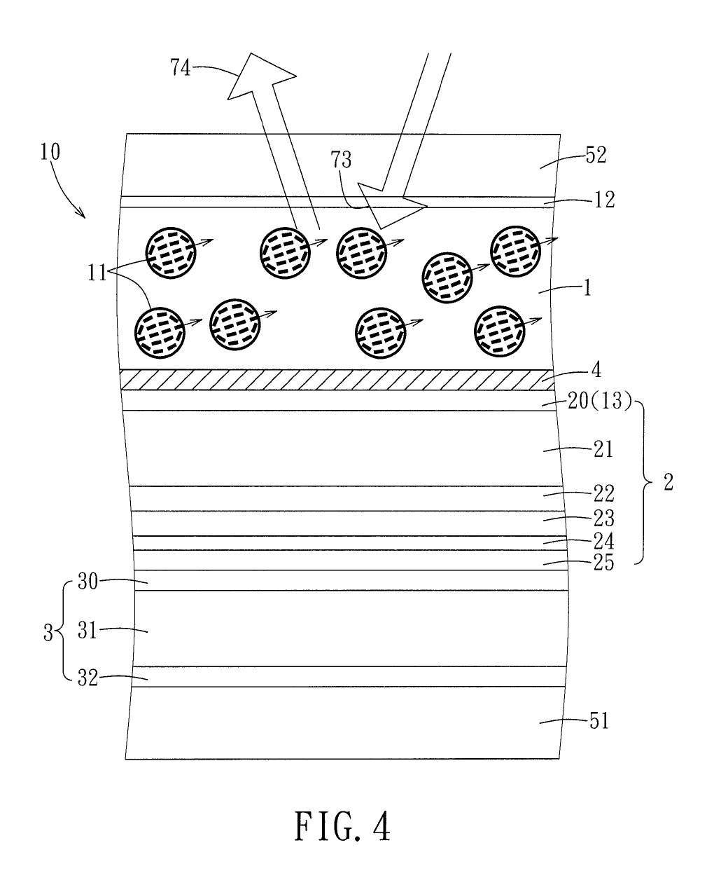

The pixel region 10 is controllable to operate at a bright state (ON state) as shown in FIGS. 2 and 4 and a dark state (OFF state) as shown in FIGS. 1 and 3. Furthermore, the pixel region 10 can generate an electrical power by itself using photoelectric effect, and the details thereof are described as follows.

Each pixel region 10 includes a liquid crystal display structure 1, an emissive display structure 2, and a photovoltaic structure 3, all of which are disposed one over the other to form a stack between the upper and lower substrates 51, 52.

It should be noted that, the liquid crystal display structure 1 and the emissive display structure 2 in each pixel region 10 are stacked one over the other, and not disposed side by side. Thus, the transflective display device according to the present invention has a higher aperture ratio.

In this embodiment, the stack is arranged, from top to bottom, in the order of the liquid crystal display structure 1, the emissive display structure 2, and the photovoltaic structure 3.

The liquid crystal display structure 1 in each pixel region 10 is disposed between the upper substrate 52 and the emissive display structure 2, and is controlled to switch between a transmissive mode (T-mode) and a reflective mode (R-mode). The liquid crystal display structure 1 has electrode layers 12, 13. The electrode layer 12 is disposed between the upper substrate 51 and the liquid crystal display structure 1, and is a transparent conductive film made of indium tin oxide (or IZO, IGZO, conductive polymer, etc). The electrode layer 13 is a mutual electrode for the liquid crystal display structure 1 and the emissive display structure 2, and is used as a first anode electrode 20 for the emissive display structure 2.

In this embodiment, the liquid crystal display structure 1 is a polymer-dispersed liquid crystal layer (PDLC layer), and includes a plurality of liquid crystal particles 11 dispersed in a monomer with a concentration of 40% by weight.

Specifically, the PDLC layer consists of a UV-curable monomer NOA65 in a nematic LC host (E48, Δn=0.231 at λ=589 nm). The concentration of NOA65 is 40% by weight. The LC host/monomer mixture was injected into an empty 90° twisted cell in the isotropic state, followed by UV exposure at an intensity of I=60 mW/cm² for 15 min at T=20° C.

When the liquid crystal display structure 1 operates in the T-mode, an external voltage from the electrode layers 12 and 13 is applied to the liquid crystal display structure 1. In this case, director axes of the liquid crystal particles 11 are parallel to an electrical field in the liquid crystal display structure 1, and thus, as shown in FIG. 1, light can pass through the liquid crystal display structure 1.

When the liquid crystal display structure 1 operates in the R-mode, a different voltage from the electrode layers 12 and 13 is applied to the liquid crystal display structure 1. In this case, the director axes of the liquid crystal particles 11 are perpendicular to the electrical field in the liquid crystal display structure 1. Thus, as shown in FIG. 4, the liquid crystal display structure 1 can reflect or scatter an ambient light 73 to form a reflective light 74, thereby placing the pixel region 10 in a bright state.

In other embodiments, the liquid crystal display structure 1 is a cholesteric liquid crystal layer or other liquid crystal layers that can also switch between T- and R-modes by controlling the applied voltage. However, the liquid crystal display structure 1 should not be limited to the aforementioned liquid crystal layers and the control method described above. For example, some liquid crystal layers can switch between T- and R-modes by controlling thickness of the liquid crystal particles 11.

The emissive display structure 2 is disposed between the liquid crystal display structure 1 and the photovoltaic structure 3, and is controllable to emit light or to not emit light. In this embodiment, the emissive display structure 2 is an organic light emitting diode (OLED) layer. As shown in FIG. 1, the emissive display structure 2 includes, from top to bottom, the first anode layer 20 which is semi-transparent, a hole transport layer 21, a light emitting layer 22, an electron transport layer 23, an electron injection layer 24, and a first cathode layer 25. By applying a predetermined driving voltage between the first anode layer 20 and the first cathode layer 25, the emissive display structure 2 is controlled to emit light 71 (see FIG. 2), thereby placing the pixel region 10 in a bright state.

The provision of the electron injection layer 24 is to facilitate injection of electrons from the first cathode layer 25 into the electron transporting layer 23. Accordingly, the driving voltage for the emissive display structure 2 can be reduced.

Preferably, the hole transport layer 21 is made of N,N-bis (naphthalene-1-yl)-N,N-bis(phenyl)benzidine (NPB) and has a thickness of 50 nm, approximately. The light emitting layer 22 and the electron transport layer 23 are made of tris-(8-hydroxyquinoline) aluminum (Alq3) and have a total thickness of 40 nm, approximately. The electron injection layer 24 is made of LiF and has a thickness of 0.5 nm, approximately. The first anode layer 20 and the first cathode layer 25 are made of aluminum, each of which has a thickness of 2.5 nm, approximately. The thickness and material of each layer 20˜25 should not be limited to this embodiment and can be varied based on the actual requirement. Note that, since each of the first anode layer 20 and the first cathode layer 25 has a thickness in nano scale, they are semi-transparent and light transmissive. Otherwise, each of the first anode layer 20 and the first cathode layer 25 can be replaced by one made of other transparent alloy such as ITO.

The photovoltaic structure 3 is disposed between the lower substrate 51 and the emissive display structure 2, and is capable of absorbing the ambient light 73 (see FIG. 3) and the light emitted from the emissive display structure 2 to generate an electrical power for the liquid crystal display structure 1 and the emissive display structure 2.

The photovoltaic structure 3 includes, from top to bottom, a second cathode layer 30, a photovoltaic layer 31 and a second anode layer 32, as shown in FIG. 1. The second cathode layer 30 is electrically connected to the first cathode layer 25. The second anode layer 32 is electrically connected to the first anode layer 20. The first and second cathode layers 25 and 30 are contiguous to each other to form a composite metal layer. Thus, the first and second cathode layers 25 and 30 provides a highly efficient electron injection pathway such that the photovoltaic structure 3 is provided with a resonance chamber for light destructive interference and for use as an anti-reflection black background when the ambient condition is dark. Furthermore, in this embodiment, since the first and second cathode layers 25 and 30 form the composite metal layer, the predetermined driving voltage for the emissive display structure 2 is applied between the first anode layer 20 and the composite metal layer of the first and second cathode layers 25 and 30.

Besides, the photovoltaic structure 3 is capable of sensing an ambient condition from the light passing through the liquid crystal display structure 1 and the emissive display structure 2. The liquid crystal display structure 1 and the emissive display structure 2 can be controlled based on the ambient condition. Especially, the emissive display structure 2 can be controlled to adjust luminance thereof by emitting graded light based on the ambient condition sensed by the photovoltaic structure 3 and to thereby reduce energy consumption thereof.

Preferably, the photovoltaic layer 31 is made of N,N′-bis(2,6-diisopropylphenyl)-1,7-bis(4-methoxyphenyl)perylene-3,4,9,10-tetracarboxydiimide, and has a thickness of 75 nm, approximately. The second cathode layer 30 is made of silver and has a thickness of 2.5 nm, approximately. The second anode layer 32 is made of aluminum and has a thickness of 150 nm, approximately. In this embodiment, since the first and second cathode layers 25 and 30 are respectively made of aluminum and sliver, the combined first and second cathode layers 25 and 30 can provide a higher light transmission compared to other nano scale metal layers made of other metals.

When the photovoltaic structure 3 detects that the ambient condition is dark, the operation of the pixel region 10 is shown in FIGS. 1 and 2. Referring to FIG. 1, if the pixel region 10 operates at its dark state (OFF state), the emissive display structure 2 is controlled to not emit light. Referring to FIG. 2, if the pixel region 10 operates at its bright state (ON state), the emissive display structure 2 is controlled to emit light 71. In both FIGS. 1 and 2, the liquid crystal display structure 1 is controlled to operate in the T-mode.

When the photovoltaic structure 3 detects that the ambient condition is bright, the emissive display structure 2 does not emit light, and the operation of the pixel region 10 is shown in FIGS. 3 and 4. Referring to FIG. 3, if the pixel region 10 operates at its dark state (OFF state), the liquid crystal display structure 1 is controlled to operate at its transmissive mode (T-mode) so that the liquid crystal particles 11 of the liquid crystal display structure 1 are controlled to be in an orientation that permits the ambient light 73 to pass through the liquid crystal display structure 1 and the emissive display structure 2 to reach the photovoltaic structure 3 which absorbs and converts the ambient light 73 into an electric energy. Referring to FIG. 4, if the pixel region 10 operates at its bright state (ON state), the liquid crystal display structure 1 is switched to operate at its reflective mode (R-mode). In this mode, the liquid crystal particles 11 of the liquid crystal display structure 1 are in an orientation that reflects and scatters the ambient light 73 to form a reflective light 74, thereby placing the pixel region 10 in the bright state.

Furthermore, as the photovoltaic structure 3 can absorb the ambient light 73, undesirable light scattered and reflected from the pixel region 10 after the ambient light 73 enters the pixel region 10 can be reduced, thereby increasing ambient contrast ratio (A-CR) when the pixel region 10 operates at its bright state. The ambient contrast ratio is expressed by the following equation:

$$A - CR = \frac{{L}_{max} + {L}_{ambient}}{{L}_{min} + {L}_{ambient}}$$

Lₘₐₓ is a maximum luminance of the pixel region 10, Lₘᵢₙ is a minimum luminance of the pixel region 10 when the pixel region 10 itself does not emit light, and L_{ambient} is luminance of a reflective light that is reflected by the photovoltaic layer 3. It is noted that the lower the L_{ambient} is, the higher A-CR will be obtained. Thus, if the photovoltaic structure 3 of the pixel region 10 in the dark state absorbs a large amount of the ambient light 73 (i.e., there is almost no reflective light from the photovoltaic layer 3), an image displayed by the pixel regions 10 of the transflective display device can be observed more clearly.

In practice, a process for forming the liquid crystal display structure 1 is incompatible with vapor deposition processes for forming the emissive display structure 2 and the photovoltaic structure 3. If the liquid crystal display structure 1 is not isolated from the emissive display structure 2, the liquid crystal in semi-liquid state will contact the organic materials of the emissive display structure 2 and degrade the photoelectrical properties of the emissive display structure 2. Thus, as shown in FIG. 1, the transflective display device in this embodiment further includes a barrier layer 4 disposed between the liquid crystal display structure 1 and the emissive display structure 2. Preferably, the barrier layer 4 is a photocurable film with a water-resisting property such that the organic materials of the emissive display structure 2 have a prolonged lifetime.

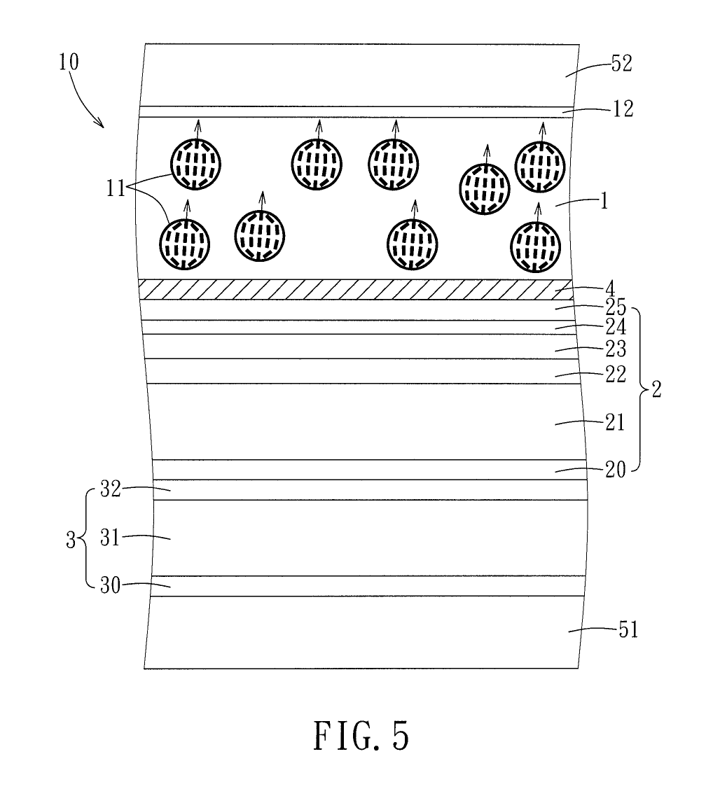

FIG. 5 illustrates a pixel region 10 of a transflective display device according to the second embodiment of the present invention. The second embodiment differs from the first embodiment only in that the layers 20 to 25 and the layers 30 to 32 are arranged in a different order. In this embodiment, the emissive display structure 2 includes, from top to bottom, a first cathode layer 25, an electron injection layer 24, an electron transport layer 23, an light emitting layer 22, a hole transport layer 21 and a first anode layer 20. For better electrical connection with the emissive display structure 2, the photovoltaic structure 3 includes, from top to bottom, a second anode layer 32, a photovoltaic layer 31 and a second cathode layer 30. The voltage applied to the liquid crystal display structure 1 can be supplied using the electrode layer 12 and the first cathode layer 25.

Furthermore, in this embodiment, the first and second cathode layers 25 and 30 are not contiguous, but the first and second anode layer 20 and 32 are contiguous to each other to form a composite metal layer. On the other hand, the first and second anode layer 20 and 32 can be simplified as one anode layer.

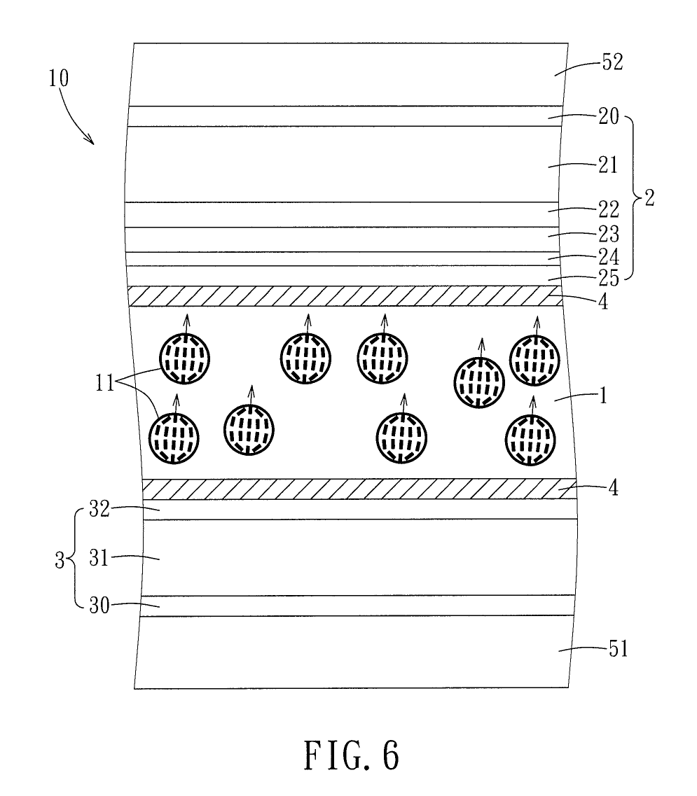

FIG. 6 illustrates a pixel region 10 of a transflective display device according to the third embodiment of the present invention. The third embodiment differs from the first embodiment only in that the stack of the pixel region 10 is arranged, from top to bottom, in the order of the emissive display structure 2, the liquid crystal display structure 1, and the photovoltaic structure 3, that the photovoltaic structure 3 includes from top to bottom, a second anode layer 32, a photovoltaic layer 31 and a second cathode layer 30, and that the electrode layer 12 of the first embodiment is not provided. In this embodiment, two barrier layers 4 are respectively disposed on upper and lower surfaces of the liquid crystal display structure 1. The emissive display structure 2 and the photovoltaic structure 3 are electrically interconnected by an outer wire (not shown). The voltage applied to the liquid crystal display structure 1 can be supplied using the first cathode layer 25 and the second anode layer 32. It should be noted that the emissive display structure 2 is pervious to light and thus, the liquid crystal display structure 1 of each pixel region 10 of the third embodiment can achieve the same functions of those of the first embodiment.

Besides, in order to further increase the ambient contrast ratio (A-CR), the liquid crystal display structures 1 and the emissive display structures 2 of the third embodiment can both work for displaying the image, regardless of whether the ambient condition is dark or bright.

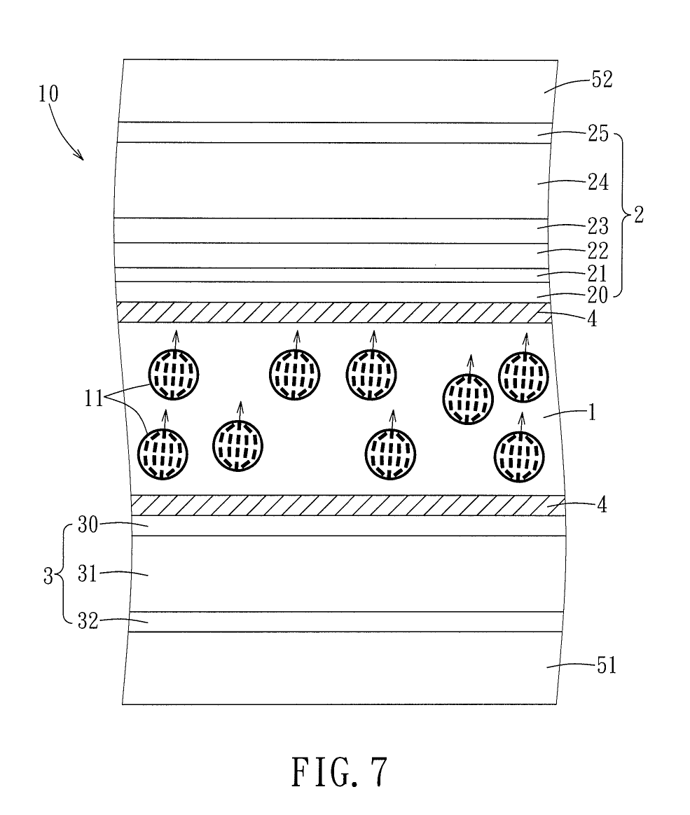

FIG. 7 illustrates a pixel region 10 of a transflective display device according to the fourth embodiment of the present invention. The fourth embodiment differs from the third embodiment only in that the layers 20 to 25 and the layers 30 to 32 are arranged in a different order. In this embodiment, the emissive display structure 2 includes, from top to bottom, a first cathode layer 25, an electron injection layer 24, an electron transport layer 23, an light emitting layer 22, a hole transport layer 21 and a first anode layer 20. The photovoltaic structure 3 includes, from top to bottom, a second cathode layer 30, a photovoltaic layer 31, and a second anode layer 32.

Moreover, the photovoltaic structure 3 can be used as an anti-reflection black background when the pixel region 10 operates at its dark state (OFF state) and as a photo sensor to detect the ambient brightness.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A transflective display device, comprising:
upper and lower substrates; and
a plurality of pixel regions, each of which includes a liquid crystal display structure, an emissive display structure, and a photovoltaic structure, all of which are disposed one over the other to form a stack between the upper and lower substrates;
the photovoltaic structure being capable of absorbing light to generate an electrical power for the liquid crystal display structure and the emissive display structure;
each of the pixel regions being controllable to switch between a bright state and a dark state;
the liquid crystal display structure being controllable to operate between a transmissive mode and a reflective mode;
the emissive display structure being controllable to emit light or to not emit light.

2. The transflective display device of claim 1, wherein the stack is arranged in the order of the liquid crystal display structure, the emissive display structure, and the photovoltaic structure.

3. The transflective display device of claim 1, wherein the stack is arranged in the order of the emissive display structure, the liquid crystal display structure, and the photovoltaic structure.

4. The transflective display device of claim 1, wherein, when an ambient condition is dark, the emissive display structure is controlled to emit gray light if the pixel region is at the bright state, and to not emit light if the pixel region is at the dark state, and the liquid crystal display structure is controlled to operate at the transmissive mode.

5. The transflective display device of claim 1, wherein, when an ambient condition is bright, the liquid crystal display structure is controlled to operate at the transmissive mode if the pixel region is at the dark state and to operate at the reflective mode if the pixel region is at the bright state, and the emissive display structure is controlled to not emit light.

6. The transflective display device of claim 1, wherein the photovoltaic structure is capable of sensing brightness or darkness of an ambient condition.

7. The transflective display device of claim 6, wherein, when the ambient condition is bright and when the liquid crystal display structure is controlled to operate at the transmissive mode, the photovoltaic structure absorbs the ambient light passing through the liquid crystal display structure to generate the electrical power and serves as an anti-reflection black background.

8. The transflective display device of claim 1, wherein the emissive display structure is an organic light emitting diode layer.

9. The transflective display device of claim 8, wherein each of the pixel regions further includes a barrier layer disposed on at least one of upper and lower surfaces of the liquid crystal display structure.

10. The transflective display device of claim 9, wherein the barrier layer is a photocurable film with a water-resisting property.

11. The transflective display device of claim 9, wherein the liquid crystal display structure is one of a polymer-dispersed liquid crystal layer and a cholesteric liquid crystal layer.

12. The transflective display device of claim 9, wherein the emissive display structure includes a first anode layer, a hole transport layer, an organic light emitting layer, an electron transport layer, and a first cathode layer in sequence.

13. The transflective display device of claim 12, wherein the emissive display structure further includes an electron injection layer disposed between the organic light emitting layer and the first cathode layer.

14. The transflective display device of claim 12, wherein the photovoltaic structure includes a second anode layer, a photovoltaic layer and a second cathode layer in sequence, the second anode layer being electrically connected to the first anode layer, the second cathode layer being electrically connected to the first cathode layer.

15. The transflective display device of claim 14, wherein the first and second cathode layers are contiguous to each other to form a composite metal layer that provides an electron injection pathway such that the photovoltaic structure is provided with a resonance chamber for light destructive interference and for use as an anti-reflection black background when an ambient condition is dark.

16. The transflective display device of claim 12, wherein the organic light emitting layer and the electron transport layer are made of tris-(8-hydroxyquinoline)aluminum.

17. The transflective display device of claim 12, wherein the hole transport layer is made of N,N-bis(naphthalene-1-yl)-N,N-bis(phenyl)benzidine.

18. The transflective display device of claim 13, wherein the electron injection layer is made of LiF.

19. The transflective display device of claim 14, wherein the photovoltaic layer is made of N,N′-bis (2,6-diisopropylphenyl)-1,7-bis(4-methoxyphenyl)perylene-3,4,9,10-tetracarboxydiimide.

20. A transflective display device, comprising:
upper and lower substrates; and
a plurality of pixel regions, each of which includes a liquid crystal display structure, an emissive display structure, and a photovoltaic structure, all of which are disposed one over the other to form a stack between the upper and lower substrates;
the photovoltaic structure being capable of absorbing light to generate an electrical power for the liquid crystal display structure and the emissive display structure;
each of the pixel regions being controllable to switch between a bright state and a dark state;
the liquid crystal display structure being controllable to operate between a transmissive mode and a reflective mode;
the emissive display structure being controllable to emit graded light or to not emit light.
